(19) United States
(12) Patent Application Publication
(10) Pub. No.: US 2007/0069919 A1
(43) Pub. Date: Mar. 29, 2007

(54) Remote control system and method for setting up and simulcasting carrier frequencies

(76) Inventor: Si-Woo Lee, Yongin-si (KR)

Correspondence Address: Robert E. Bushnell, Suite 300, 1522 K Street, N.W., Washington, DC, 20005-1502, US

(21) Appl. No.: 11/480,531

(22) Filed: Jul. 5, 2006

(30) Foreign Application Priority Data
Sep. 23, 2005 (KR) 10-2005-0088970

(51) Int. Cl. G05B 19/02; G08C 19/12

(52) U.S. Cl. 340/825.72; 341/176; 340/825.22

(57) ABSTRACT

In a remote control system and a method for setting up and simulcasting carrier frequencies, a carrier frequency is set up according to a carrier frequency setup signal inputted by a user, and digital data of a signal corresponding to a button pushed by a user for controlling a remote control receiver are modulated onto the setup carrier frequency, and the modulated digital data are sent out.

### CLAIM OF PRIORITY

This application makes reference to, incorporates the same herein, and claims all benefits accruing under 35 U.S.C. §119 from an application for CARRIER FREQUENCY SET UP AND OUTPUT SYSTEM AND METHOD ON REMOCON TRANSMITTER filed in the Korean Intellectual Property Office on 23 Sep. 2005 and there duly assigned Ser. No. 10-2005-0088970.

### BACKGROUND OF THE INVENTION

1. Field of the Invention

The present invention relates to a system and method used in a remote control transmitter for setting up and simulcasting a single carrier frequency or multiple carrier frequencies.

2. Description of the Related Art

In general, a remote controller is a device that controls various functions of electronic equipment, such as a television (TV), a video tape recorder (VTR), audio equipment, an air conditioner, a cable broadcasting converter, a satellite broadcasting converter, an electric fan, and so forth, from a distance by means of transmission of an infrared signal. Remote controllers for such electronic equipment use different data formats and different carrier frequency bands depending on the type of equipment and the maker in order to prevent other equipment from malfunctioning. Thus, a different infrared remote control transmitter is used for the carrier frequency of an infrared receiver built into each household appliance or remote control receiving device. It is impossible to remotely control an electronic device with a remote controller using a different carrier frequency from the infrared receiver of the electronic device; only a remote controller in which a corresponding carrier frequency is set up can be used.

One problem with each electronic device being controlled by a different remote controller using a single frequency is that, in some lighting environments created by light sources that give off infrared radiation, such as a three-wavelength fluorescent lamp, and so forth, there may be interference at the frequency of the remote control transmitter signal, which can hinder normal operation.

### SUMMARY OF THE INVENTION

It is an object of the present invention to provide a remote control system and method for setting up and simulcasting carrier frequencies. According to the remote control system and method, a user personally sets up carrier frequencies of an infrared remote control transmitter, and the remote control transmitter continuously sends out all the setup carrier frequencies. Thus, all household appliances or remote control receiving devices, the frequencies of which are set up, can be simultaneously, remotely controlled by the same remote controller.

According to an aspect of the present invention, there is provided a frequency interference prevention remote controller comprising a controller for setting up a carrier frequency according to a carrier frequency setup signal inputted by a user, for modulating digital data of a button input signal so as to control a remote control receiving device onto the setup carrier frequency, and for sending out the modulated digital data.

When the carrier frequency setup signal is a single carrier frequency signal, the controller may set up the single carrier frequency signal, modulate the digital data of the button input signal so as to control the remote control receiving device onto the setup single carrier frequency signal, and send out the modulated digital data.

When the setup single carrier frequency is subject to interference, the controller may set up a new single carrier frequency and continuously send out the digital data of the button input signal so as control the remote control receiver.

When the input carrier frequency setup signal is a multi-carrier-frequency setup signal, the controller may set up multiple carrier frequencies, modulate the digital data of the button input signal for controlling the remote control receiver onto the setup multiple carrier frequencies, and send out the modulated digital data in sequence.

The digital data may be modulated onto the multiple carrier frequencies at regular intervals in sequence.

According to another aspect of the present invention, there is provided a frequency interference prevention method comprising the steps at a remote controller of: receiving a carrier frequency setup signal input by a user; setting up a carrier frequency according to the carrier frequency setup signal input by the user; modulating digital data of a signal of a button pressed by the user onto the setup carrier frequency; and sending out the modulated digital data.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 illustrates an example of general data transmission performed by a remote controller;

FIG. 2 is a block diagram of a remote controller which sets up and simulcasts a plurality of carrier frequencies according to the present invention;

FIGS. 3 and 4 illustrate examples of multi-carrier-frequency transmission according to the present invention;

FIG. 5 illustrates an exemplary embodiment of a plurality of buttons making up a button pad of FIG. 2; and

FIG. 6 is a flowchart showing a method of setting up and simulcasting multiple carrier frequencies using a remote control transmitter according to the present invention.

### DETAILED DESCRIPTION OF EXEMPLARY EMBODIMENTS

Hereinafter, exemplary embodiments of the present invention will be described in detail with reference to the accompanying drawings. Like elements are denoted by like reference numerals throughout the drawings. Matters related to the present invention and well-known in the art will not be described in detail when it is deemed that such description would detract from the clarity and concision of the disclosure.

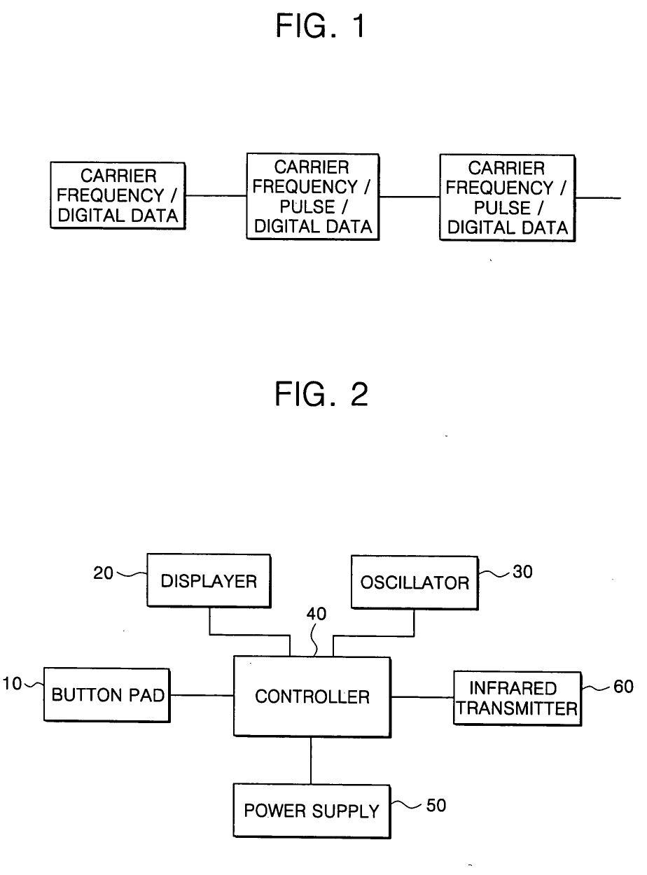

FIG. 1 illustrates an example of general data transmission performed by a remote controller.

As illustrated in FIG. 1, when a user presses a specific button on the remote controller, digital data corresponding to the button is sent out together with an infrared signal. In this respect, a uniform pulse and the data are mixed in various ways depending on a data mixing method, and are repeatedly sent out at regular intervals. An infrared receiver of a remote control receiving device receives the digital data of the sent infrared signal, continuously receiving the pulse and data at regular intervals, and performs an electronic device control operation corresponding to the digital data.

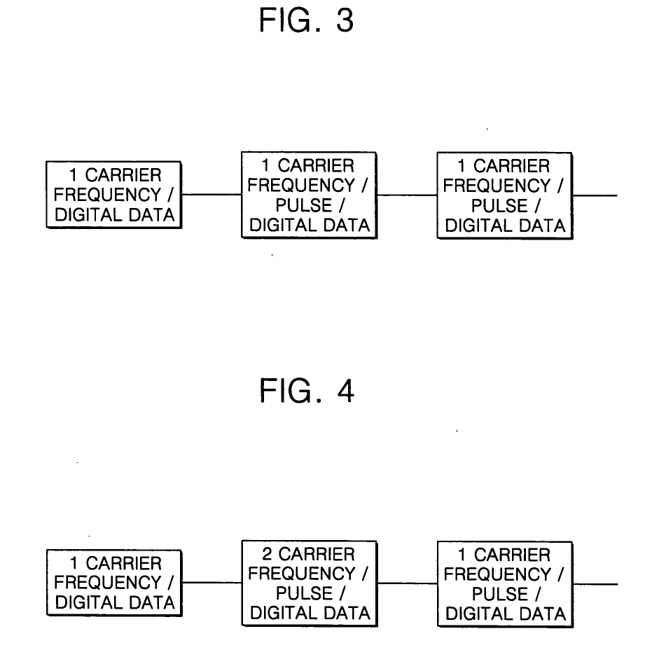

FIG. 2 is a block diagram of a remote controller which sets up and simulcasts a plurality of carrier frequencies according to the present invention. FIGS. 3 and 4 illustrate examples of multi-carrier-frequency transmission according to the present invention.

As illustrated in FIG. 2, the remote controller of the present invention comprises a button pad 10, a displayer 20, an oscillator 30, a controller 40, a power supply 50, and an infrared transmitter 60.

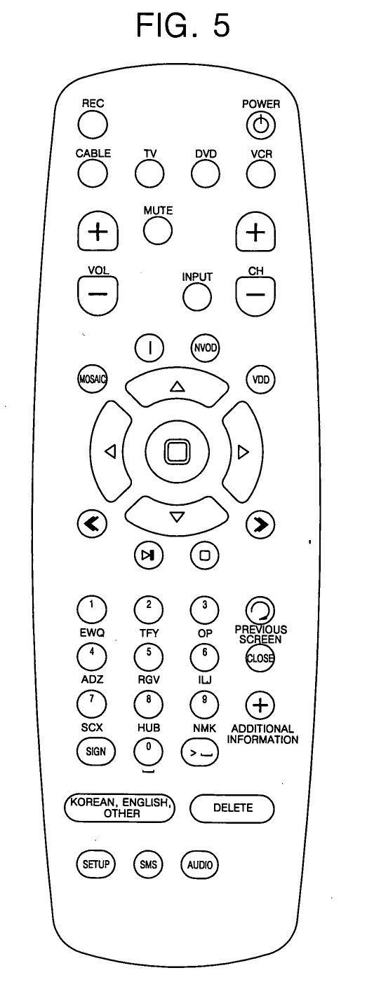

The button pad 10 is formed into a matrix structure in which an X axis and a Y axis cross each other. When an arbitrary contact point where the X axis and Y axis cross each other is selected, the button pad 10 transmits a selection signal, generated by a voltage drop, to the controller 40. The button pad 10 is made up of a plurality of function buttons, each performing a different function, which will be described below in detail with reference to FIG. 5.

In particular, the user can personally set up a single carrier frequency by means of the button pad 10. For example, when the user controls a household appliance or remote control receiving device with a first carrier frequency and the remote controller does not operate normally due to interference from a three-wavelength fluorescent lamp or illuminator, the user can set up a second carrier frequency. When the user wants to change the carrier frequency, the user can shift the remote controller into a carrier frequency setup mode, input a carrier frequency with number keys mounted on the button pad 10, and press a confirmation button. Thereby, a desired first carrier frequency and/or a second carrier frequency is set up.

When a carrier frequency is set up according to a signal that is generated with the number keys by the user and transmitted from the button pad 10, and digital data corresponding to a specific button is transmitted from the button pad 10, the controller 40 outputs the transmitted digital data with the setup carrier frequency.

For example, when the controller 40 outputs digital data corresponding to a specific button with the second carrier frequency set up by the user through the button pad 10, and the remote controller does not operate properly due to interference of a three-wavelength fluorescent lamp, illuminator, or the like outputting the same frequency as the second carrier frequency, the user can set up the first carrier frequency with the button pad 10, and the controller 40 continuously outputs the same digital data modulated onto the setup first carrier frequency, as shown in FIG. 3.

In addition, when a multi-carrier-frequency setup signal is generated according to multi-carrier-frequency values inputted by the user, the controller 40 causes the first carrier frequency, the second carrier frequency and a third carrier frequency to be automatically modulated at regular intervals, and then allows digital data corresponding to a specific button operated by the user to be outputted onto the automatically modulated first and second carrier frequencies.

In other words, when a plurality of carrier frequencies is set up to be automatically modulated as illustrated in FIG. 4, while the user selects and presses down a specific button of the button pad 10, digital data of a signal of the selected button is modulated onto the first, second, and so on carrier frequencies at regular intervals, and is continuously sent out.

The oscillator 30 applies a predetermined clock signal to the controller 40 to cause the controller 40 to operate in a stable manner.

The infrared transmitter 60 sends out digital data transmitted from the controller 40 together with an infrared signal at carrier frequencies that are personally set up by the user or automatically modulated to a household appliance or a remote control receiving device which the user wants to control.

Specifically, the output signal of an infrared remote control transmitter is made up of digital data, a carrier frequency, and an infrared signal. When the user presses down a button of the remote controller, the digital data is modulated two times by the carrier frequency and infrared signal, and sent out in sequence.

In this regard, all household appliances or remote control receiving devices having an infrared receiver which the user wants to control continuously receive the digital data that is modulated onto the carrier frequencies personally set up by the user or set up automatically, and perform operations corresponding to the digital data.

The power supply 50 maintains backup power for a predetermined time when a battery has been discharged, stabilizes voltage and current of the battery, and thereby supplies respective loads with power.

The displayer 20 displays operation states of the remote controller operated by control of the controller 40 so that the user can check the operation states.

FIG. 5 illustrates an exemplary embodiment of a plurality of function buttons making up the button pad of FIG. 2. This embodiment will be described by taking the example of a remote controller for controlling a digital broadcasting receiver.

As illustrated in FIG. 5, the remote controller of the present invention includes a “REC” button having a function which causes a video cassette recorder (VCR) to record a moving picture, and a “Power” button having a function which causes the digital broadcasting receiver to shift to an operation or standby mode.

In addition, the remote controller includes a “Cable” button selected when the user operates the digital broadcasting receiver with the remote controller, a “TV” button selected when the user operates a television (TV) with the remote controller, a “DVD” button selected when the user operates a digital versatile disc (DVD) player with the remote controller, and a “VCR” button selected when the user operates a VCR with the remote controller.

In addition, the remote controller includes “VOL(+/−)” buttons for adjusting the volume, a “MUTE” button for temporarily turning off an audio signal, an “INPUT” button for setting up an external input medium of the TV, and “CH(+/−)” buttons used for selecting a channel.

Furthermore, the remote controller includes a “MOSAIC” button for displaying an electronic program guide (EPG) menu screen, an “i” button for displaying a data service screen, an “NVOD” button for displaying a pay-per-view (PPV) service screen, and a “VOD” button for displaying a video-on-demand (VOD) menu screen.

In addition, the remote controller includes directional buttons used for navigating menus, and a confirmation button for selecting items from the menus.

The remote controller also includes a button for rewinding a VOD program, a button for playing and temporarily stopping the VOD program, a button for fully stopping the VOD program, and a button for fast-forwarding the VOD program.

In addition, the remote controller includes number keys for inputting a channel number, a secret number, characters, and so forth, a button for inputting special characters and symbols, a button for spacing, a button for displaying a previous screen, a button for closing a menu screen and displaying a TV screen, and a button for displaying additional information about a corresponding channel program.

In addition, the remote controller includes a button for shifting into Korean, English, and Special character modes, a button for deleting input characters one-by-one, a button for displaying a user setup menu screen, a button for displaying a text message menu screen, and a button for displaying an audio channel service screen.

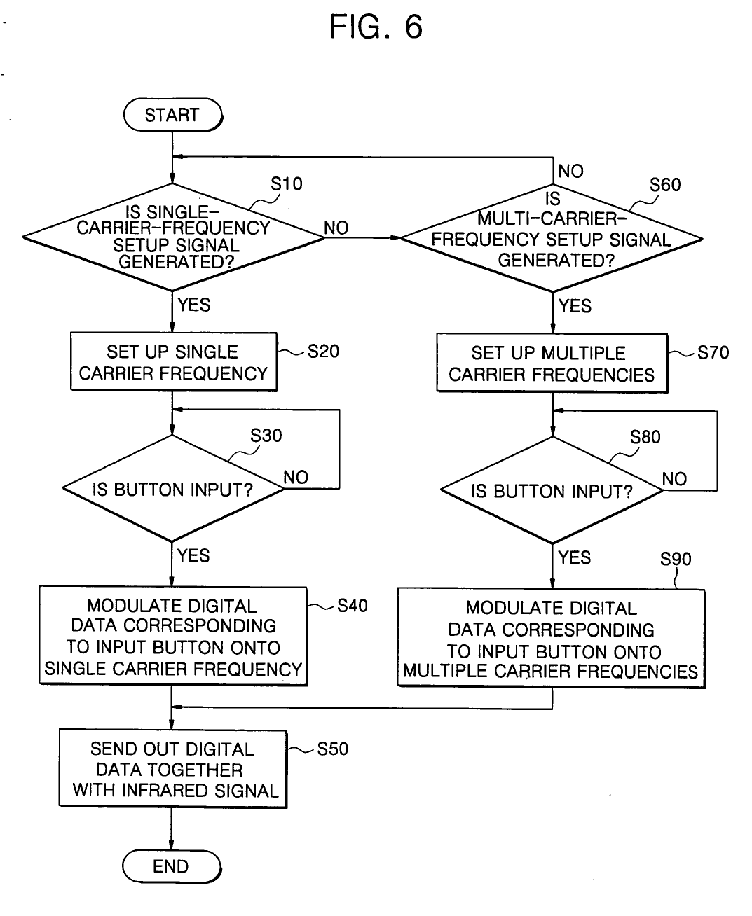

FIG. 6 is a flowchart showing a process for setting up and simulcasting multiple carrier frequencies in a remote control transmitter according to the present invention.

As illustrated in FIG. 6, the remote control transmitter first determines whether a single-carrier-frequency signal corresponding to a single carrier frequency value inputted by a user is generated (S10). When the single-carrier-frequency setup signal is generated, a single carrier frequency is set up according to the single-carrier-frequency setup signal (S20).

Subsequently, the remote control transmitter determines whether a specific-button input signal for controlling a remote control receiver is generated according to a button pressed by the user (S30). When the input signal of the specific button is generated, digital data corresponding to the pressed button is modulated onto the single carrier frequency set up by the user (S40), sent out to the remote control receiving device together with an infrared signal (S50), and then stored.

For example, when the digital data corresponding to the specific button is outputted at a first carrier frequency set up by the user, and the remote controller does not operate properly due to interference of a three-wavelength fluorescent lamp, illuminator or the like outputting the same frequency as the first carrier frequency, then the user presses desired number keys of the button pad to input predetermined numbers, a second carrier frequency is set up according to the input numbers, and thus the same digital data is continuously sent out at the setup second frequency.

In the step of determining whether the single-carrier-frequency setup signal is inputted or not, when the single-carrier-frequency setup signal is not generated (S10), the remote controller determines whether a multi-carrier-frequency setup signal is generated (S60). When the multi-carrier-frequency setup signal is generated, multiple carrier frequencies are set up according to the multi-carrier-frequency setup signal (S70).

Specifically, when the multi-carrier-frequency setup signal is generated according to multi carrier frequency values inputted by the user, the first carrier frequency, second carrier frequency, and a third carrier frequency (e.g., carrier frequencies of 38 KHz, 56 KHz, and so forth) are automatically modulated at regular intervals.

Subsequently, the remote control transmitter determines whether the specific-button input signal for controlling the remote control receiving device is generated (S80). When the specific-button input signal is generated, digital data corresponding to the pressed button are modulated onto the multi-carrier-frequencies set up by the user (S90), sent out to the remote control receiving device together with an infrared signal (S50), and then stored.

Specifically, the digital data corresponding to the specific button operated by the user is modulated onto various carrier frequencies (e.g., automatically modulated carrier frequencies of 38 KHz and 56 KHz) and are sent out to the remote control receiving device by an infrared signal.

According to the present invention, a user personally sets up carrier frequencies of an infrared remote control transmitter, and the remote control transmitter continuously sends out all the setup carrier frequencies. Therefore, it is possible to overcome electromagnetic interference caused by a three-wavelength fluorescent lamp, illuminator or the like, and to simultaneously remote control a plurality of household appliances or remote control receiving devices using different carrier frequencies.

While the present invention has been described with reference to exemplary embodiments thereof, it will be understood by those skilled in the art that various changes in form and detail may be made therein without departing from the scope of the present invention as defined by the following claims.

What is claimed is:

1. A frequency interference prevention remote controller, comprising:
means for setting up a carrier frequency according to a carrier frequency setup signal inputted by a user,
means for modulating digital data of a button input signal for controlling a remote control receiving device onto the setup carrier frequency; and
means for sending out the modulated digital data.

2. The frequency interference prevention remote controller of claim 1, wherein when the carrier frequency setup signal is a single carrier frequency signal, the controller sets up the single carrier frequency signal, modulates the digital data of the button input signal for controlling the remote control receiving device onto the setup single carrier frequency signal, and sends out the modulated digital data.

3. The frequency interference prevention remote controller of claim 2, wherein when the setup single carrier frequency is subject to interference, the controller sets up a new single carrier frequency, and continuously sends out the digital data of the button input signal for controlling the remote control receiver.

4. The frequency interference prevention remote controller of claim 1, wherein when the input carrier frequency setup signal is a multi-carrier-frequency setup signal, the controller sets up multiple carrier frequencies, modulates the digital data of the button input signal for controlling the remote control receiver onto the setup multiple carrier frequencies, and sends out the modulated digital data in sequence.

5. The frequency interference prevention remote controller of claim 4, wherein the digital data is modulated onto the multiple carrier frequencies at regular intervals in sequence.

6. A frequency interference prevention method, comprising the steps at a remote controller of:
receiving a carrier frequency setup signal inputted by a user;
setting up a carrier frequency according to the carrier frequency setup signal inputted by the user;
modulating digital data of a signal of a button pressed by the user onto the setup carrier frequency; and
sending out the modulated digital data.

7. The frequency interference prevention method of claim 6, wherein when the input carrier frequency setup signal is a single-carrier-frequency setup signal, a single carrier frequency is set up according to the single-carrier-frequency setup signal, and the digital data of the signal of the button pressed by the user is modulated onto the setup single carrier frequency and sent out.

8. The frequency interference prevention method of claim 7, wherein when the setup single carrier frequency is subject to interference, a new single carrier frequency is set up, and the digital data of the signal of the button pressed by the user is continuously sent out.

9. The frequency interference prevention method of claim 6, wherein when the input carrier frequency setup signal is a multi-carrier-frequency setup signal, multiple carrier frequencies are set up, and the digital data of the signal of the button pressed by the user is modulated onto the setup multiple carrier frequencies, and is sent out in sequence.

10. The frequency interference prevention method of claim 9, wherein the digital data is modulated onto the multiple carrier frequencies at regular intervals in sequence.
